(19) United States
(12) Patent Application Publication
(10) Pub. No.: US 2015/0193796 A1
(43) Pub. Date: Jul. 9, 2015

(54) DYNAMIC PROPERTY PRICING SYSTEM, SOFTWARE WITH DYNAMIC PRICING AND METHOD OF PERFORMING SAME

(71) Applicant: Michael J. Gerrity, Miami, FL (US)

(72) Inventor: Michael J. Gerrity, Miami, FL (US)

(21) Appl. No.: 14/148,381

(22) Filed: Jan. 6, 2014

(51) Int. Cl. G06Q 30/02; G06Q 50/16

(52) U.S. Cl. CPC G06Q 30/0206; G06Q 50/16

(57) ABSTRACT

A dynamic pricing system including a dynamic pricing unit including a memory and a processor, the processor of the dynamic pricing unit executing a program performing the steps of gathering a plurality of information on a unit of property not real estate property, gathering a plurality of information on a market where the unit of property is sold, generating a first price for the unit of property based on the gathered information on the unit of property and market information, generating a second price and a third price based on the first price for the unit of property, posting a portion of the plurality of property information and the first price for viewing by potential buyers on a first web site, posting a portion of the plurality of property information and the second price for viewing by potential buyers on a second web site, posting a portion of the plurality of property information and the third price for viewing by potential buyers on a third web site, monitoring each of the first, second and third web sites to determine the level of interest in the unit of property at each of the first price, second price and third price, determining a final price based on the interest level of the web posting for the first price, second price and third price, posting a portion of the plurality of property information and the final price for viewing by potential buyers on a final web site.

### FIELD OF THE INVENTION

The current invention relates to a dynamic system using online tools for determining dynamically the value of any property being non real estate property, more specifically a system capable of determining the equilibrium market price of property based on potential consumer reactions to sale offers.

### BACKGROUND OF THE INVENTION

Owners and investors in property generally need estimated valuations of their properties to determine the ideal price to sell. For example, owners of a portfolio of priceless art, boats, jewelry, or any other good generally sold at market need to constantly evaluate the price of the property. Experts, such as auction systems also need efficient third party evaluation of property to help with sales. Many methods of valuating property exist including reviewing tax and sales records of comparable properties, using previous sales data, or scouring the internet to find the price of comparable property.

Ultimately, the value of any given piece of property is the value a buyer is willing to pay for the property on any given day. One method of valuating a property automatically involves a seller placing their product or service for sale, auction or lease on an Internet based web-site where a buyer or seller could then request, review and determine a proper price model based upon a mathematical algorithm calculating length of time on the market, number of inquiries and percentages of successful sales transactions based upon mapping the above equations against each other over time. Often, a person will call an agent, investigate as to increases of market in the region or even try to obtain online comparable properties sold recently in the area. Each of these methods are time extensive and costly.

While these methods provide valuation methods for properties, they do not provide a reliable method of determining a real market valuation for a property without the need of external third party data and input. There is currently no system capable of determining with a great degree of reliability the current value of a property without extensive investigation. A need exists for a system that will allow a user to dynamically determine the real market valuation for a property using simply and available tools.

### SUMMARY OF THE INVENTION

In one example, a dynamic pricing system includes a dynamic pricing unit including a memory and a processor, the processor of the dynamic pricing unit executing a program performing the steps of gathering a plurality of information on a property unit wherein the property is any property but real estate property, gathering a plurality of information on a market where the property unit is sold, generating a first price for the property unit based on the gathered property unit information and market information, generating a second price and a third price based on the first price for the property unit, posting a portion of the plurality of property information and the first price for viewing by potential buyers on a first web site, posting a portion of the plurality of property information and the second price for viewing by potential buyers on a second web site, posting a portion of the plurality of property information and the third price for viewing by potential buyers on a third web site, monitoring each of the first, second and third web sites to determine the level of interest in the property unit at each of the first price, second price and third price, determining a final price based on the interest level of the web posting for the first price, second price and third price; posting a portion of the plurality of property information and the final price for viewing by potential buyers on a final web site.

In another example, the property unit is collectible property.

In another example, the property unit is a product.

In another example, the second price is higher than the first price and third price.

In another example, the third price is lower than the first price and second price.

In another example, the final price is a value between the first price and second price.

In another example, the market information includes pricing information for a plurality of comparable property units having similar characteristics as the property unit.

In another example, the dynamic pricing unit performs the step of normalizing the pricing information of each of the plurality of comparable property unit based on the property unit information.

In another example, the dynamic pricing unit performs the step of gathering information relating to users viewing each of the first web page, second web page and third web page.

In another example, the dynamic pricing unit performs the step of adjusting the final price based on the information relating to users viewing each web site.

In another example, a dynamic pricing system includes a property analysis unit configured to gather a plurality of information on a property unit wherein the property is any property but real estate property, a market analysis unit configured to gather a plurality of information on a market where the property unit is sold, a property analysis unit configured to generate a first price for the property unit based on the gathered property unit information and market information, generate a second price and a third price based on the first price for the property unit, a property posting unit configured to post a portion of the plurality of property information and the first price for viewing by potential buyers on a first web site, post a portion of the plurality of property information and the second price for viewing by potential buyers on a second web site, post a portion of the plurality of property information and the third price for viewing by potential buyers on a third web site, monitoring each of the first, second and third web sites to determine the level of interest in the property unit at each of the first price, second price and third price, a pricing analysis unit configured to determine a final price based on the interest level of the web posting for the first price, second price and third price, post a portion of the plurality of property information and the final price for viewing by potential buyers on a final web site.

In another example, the property unit is collectible property.

In another example, the property unit is a product.

In another example, the second price is higher than the first price and third price.

In another example, the third price is lower than the first price and second price.

In another example, the final price is a value between the first price and second price.

In another example, the market information includes pricing information for a plurality of comparable property units having similar characteristics as the property unit.

In another example, the property analysis unit normalizes the pricing information of each of the plurality of comparable property unit based on the property unit information.

In another example, the property posting unit gathers information relating to users viewing each of the first web page, second web page and third web page.

In another example, the pricing analysis unit adjusts the final price based on the information relating to users viewing each web site.

### BRIEF DESCRIPTION OF THE DRAWING

Details of the present invention, including non-limiting benefits and advantages, will become more readily apparent to those of ordinary skill in the relevant art after reviewing the following detailed description and accompanying drawings.

FIG. 1 depicts a block diagram of an dynamic pricing system suitable for use with the methods and systems consistent with the present invention.

FIG. 2 shows a more detailed depiction of the dynamic pricing unit.

FIG. 3 shows a more detailed depiction of the computers.

FIG. 4 depicts an illustrative example of the operation of the dynamic pricing system.

FIG. 5 depicts an illustrative example of the operation of the pricing analysis unit gathering market information.

FIG. 6 is an illustrative example of the operation of the property posting unit adjusting the price of the target property based on activity from various web postings of the property.

FIG. 7 is an illustrative example of a website for the listing of property where the dynamic pricing model can be used according to an embodiment of the present invention.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

Described herein is a system for dynamically determining the real market value for a property of product. The system determines an initial price based on information on comparable properties or products, and posts the property or product at different prices via various web pages. The system then gauges interest in the product or property to determine the real market value of the product or property. While the examples below describe the use of the system for real estate, the system can be used to valuate any products such as furniture, consumer products, collectible items or any other item capable of being valued.

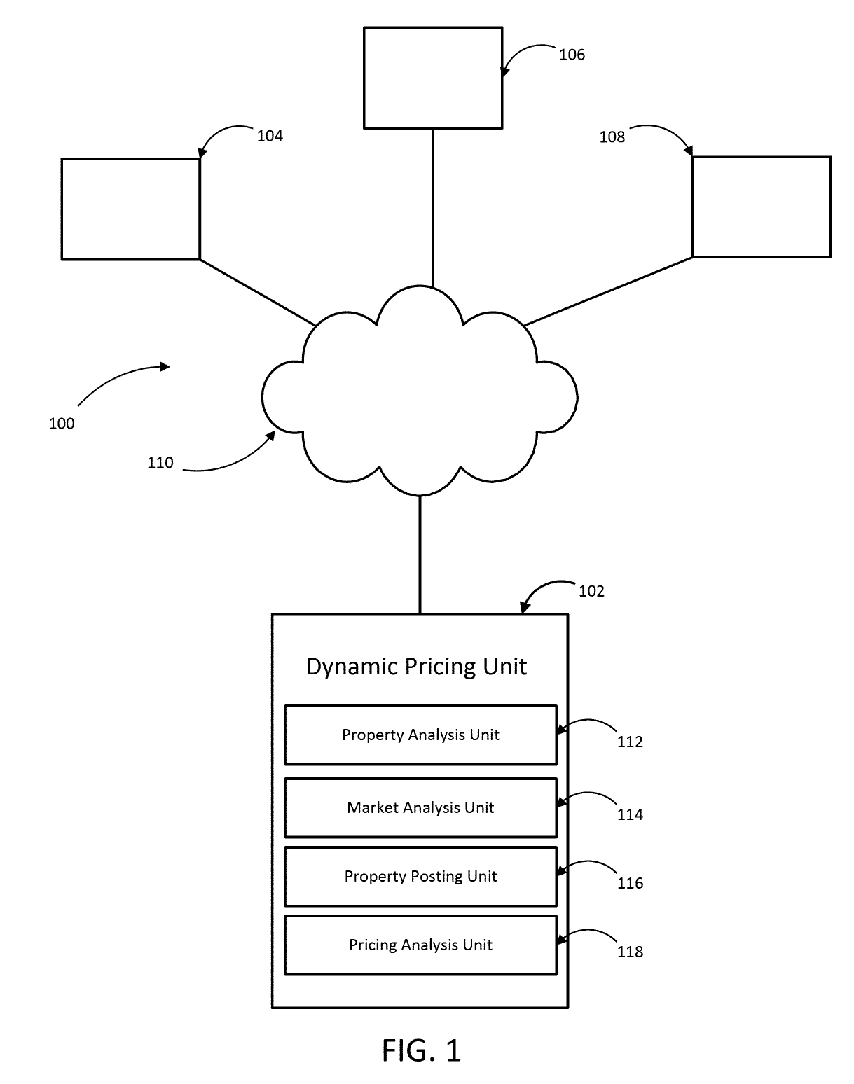

FIG. 1 depicts a block diagram of an dynamic pricing system 100 suitable for use with the methods and systems consistent with the present invention. The dynamic pricing system 100 comprises a plurality of computers 102, 104, 106 and 108 connected via a network 110. The network 108 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104, 106 and 108 shown in FIG. 1 is connected to the network 110 via a suitable communication link, such as a dedicated communication line or a wireless communication link.

In an illustrative example, computer 102 serves as a dynamic pricing unit that includes a property analysis unit 112, a market analysis unit 114, a property posting unit 116 and a pricing analysis unit 118. The number of computers and the network configuration shown in FIG. 1 are merely an illustrative example. One having skill in the art will appreciate that the dynamic pricing system 100 may include a different number of computers and networks. For example, computer 102 may include the property analysis unit 112 as well as one or more of the market analysis unit 114 and pricing analysis unit 118. Further, the property posting unit 116 may reside on a different computer than computer 102.

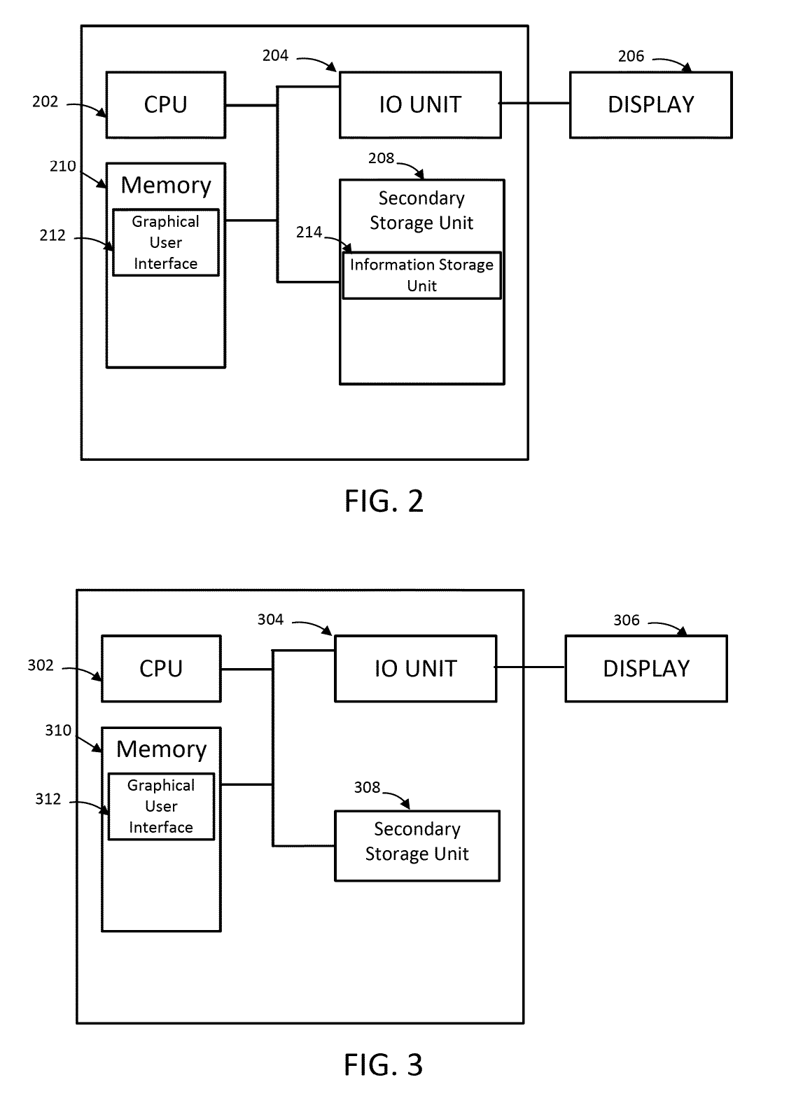

FIG. 2 depicts a more detailed depiction of the computer 102. The computer 102 comprises a central processing unit (CPU) 202, an input output (I0) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102's memory 210 includes a Graphical User Interface (“GUI”) 212 which is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a rational database such as, but not including Microsoft's SQL, Oracle or any other database.

FIG. 3 shows a more detailed depiction of the computers 104, 106 and 108. Each computer 104, 106 and 108 comprises a central processing unit (CPU) 302, an input output (I/O) unit 304, a display device 306 communicatively coupled to the IO Unit 304, a secondary storage device 308, and a memory 310. Each computer 104, 106 and 108 may further comprise standard input devices such as a keyboard, a mouse, a digitizer, or a speech processing means (each not illustrated).

Each computer 104, 106 and 108's memory 310 includes a GUI 312 which is used to gather information from a user via the display device 306 and I/O unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available hypertext markup language (“HTML”) viewing software such as, but not limited to, Microsoft Internet Explorer, Google Chrome or any other commercially available HTML viewing software.

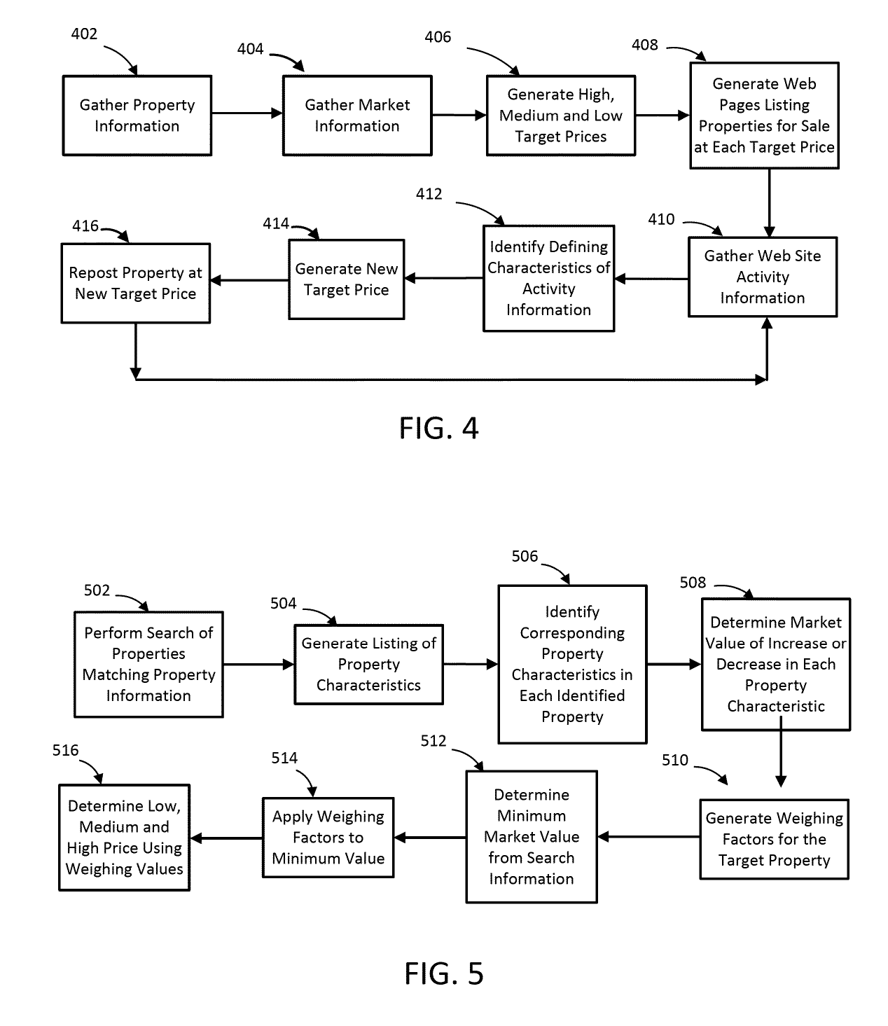

FIG. 4 depicts an illustrative example of the operation of the dynamic pricing system 100. In step 402, the property analysis unit 112 gathers information on a specific property (“target property”). The information may be gathered via a web page displayed on a GUI 212 or 312 that requests specific information on the property including the address of the property, number of bedrooms, total number of rooms, mechanical and electrical systems installed on the property, lot size and any other information relating to the property. The property analysis unit 112 may also retrieve information on the property from public records available such as tax records or deed records. The property analysis unit 112 may identify the municipality where the property is located and electronically contact the municipality to request additional information on the property.

The property analysis unit 112 may analyze and store documents pertaining to the property that are retrieved from external sources. As an illustrative example, the property analysis unit 112 may retrieve an electronic version plat of survey and calculate the dimensions of the lot where the property resides using known document analysis techniques such as Object Character Recognition (“OCR”), line analysis or any other method of extracting data from a document. At a minimum, the property analysis unit will gather the property address, lot size, number of bedrooms, number of bathrooms, total number or rooms, and total square footage of the property. The property analysis unit 112 may gather additional information on the property such as the schools associated with the property address, crime reports for the area surrounding the property or any other additional information on the property.

In step 404, the market analysis unit 114 will gather information comparable to the information gathered on the target property for the real estate market where the target property resides. The market analysis unit 114 may gather information on properties in the market having similar characteristics as the target property such as the same lot size, same number of bedrooms or bathrooms, same square footage, or based on any other similar characteristic. The market analysis unit 114 also gathers sale and purchase information on each property including the year and date of the last sale of a property, the amount the property was listed for and the amount the property sold.

In step 406, the market analysis unit 114 generates a high value, low value and medium value for the target property based on the property information and the market information. The market analysis unit 114 may compare prior sales of similar properties to the target property to determine the high, medium and low price points. As an illustrative example, the market analysis unit 114 may set the low price as the lowest price sold for a property having the same or similar square footage, number of bedrooms and number of bathrooms. The market analysis unit 114 may also apply adjustment or weighing factors to compensate for differences in the characteristics of the property. As another illustrative example, the market analysis unit 114 may increase a price by a predefined amount based on differences between the target property and a comparable property. In determining the low, medium and high prices, the market analysis unit 114 may require the low, medium and high prices be separated by a minimum amount of money to ensure the properties are separated during searches.

In step 408, the property posting unit 116 generates and displays separate web pages for the low, medium and high price for the target property. Each web page includes the same images and description of the property, but lists the property for a different price. The web pages may be listed on the same website or on different websites. In one embodiment, the property posting unit 116 stores a listing of property sales web sites and posts identical listings on each property sales web site. In another embodiment, the property posting unit 116 posts one web page on separate web sites and adjusts the pricing of the property between the high, low and medium price over a predetermined time period.

In step 410, the property posting unit 116 monitors user activity for each of the posted web pages. The property posting unit 116 may monitor and store the number of instances a web page is viewed, the number of e-mails sent concerning a posting, demographic information on the users viewing each posting or any other information relating to the users viewing each posting. In step 412, the property posting unit 116 gathers all information on each posting and analyzes the information relating to each posting. The property posting unit 116 may assign a value to each posting based on the number of times a user viewed each posting, the demographic information on the person viewing each posting, the number of correspondence from users for each posting or any other information related to the posting.

The value assigned to each posting represents the likelihood that the purchase price of the target property is accurate. The value may be determined based on the both the quantity and quality of the interest shown in the posting. As an illustrative example, a posting that receives a large number of views and associated correspondence will receive a higher value than a property receiving a smaller number of views. The property posting unit 116 may also review the time period during which the properties are viewed. As another illustrative example, a property that is viewed a number of times over an extended period would receive a higher value than a property that is viewed a similar number of times immediately after the property is posted.

In step 414, a new price for the target property is generated using the values calculated for each posting. The new price may be the low price, medium price, high price or a value between the high price and low price. As an illustrative example, if the high price and medium price are assigned similar values, the property posting unit 116 may calculate a target price between the medium price and high price. If the low price and high price receive the same or similar value, the target price maybe a value between the low price and the high price.

In step 416, the property posting unit 116 posts a new web page for the target property at the target price. In addition, the property posting unit 116 may post additional postings for the property with the value of the property offset by a predetermined value. The property posting unit 116 may analyze the new postings using the same criteria previously discussed.

FIG. 5 depicts an illustrative example of the operation of the pricing analysis unit 118 gathering market information. In step 502, the pricing analysis unit 118 performs a search of property sales databases to identify properties having the same or similar characteristics as the target property. As an illustrative example, the pricing analysis unit 118 may search a database listing properties sold or currently for sale in the same geographical area as the target property. The pricing analysis unit 118 may search for properties having the same or similar characteristics as the target property such as properties having the same or similar bedrooms or square footage.

In step 504, the pricing analysis unit 118 generates a list of identifying characteristics in the target property. The identifying characteristics may be any defining characteristic of the property such as the number of bedrooms, the total square footage of the property, the number of garages or parking spots, the acreage where the property resides, the number of floors in the property or any other physical attribute of the property. The identifying characteristics may also include information on the community where the property resides, including the ratings of the schools in the area, the crime rate in the area, the average income of the residents of the area or any other information relating to the market where the property resides.

In step 506, the pricing analysis unit 118 identifies characteristics in the identified properties that correspond to each of the characteristics in the target property. In step 508, the pricing analysis unit 118 adjusts the market value of each identified property based on differences between the identified property and the target property. As an illustrative example, the pricing analysis unit 118 may reduce the value of the identified property if the identified property is located on a lot having less acreage than the target property. In determining the amount the value of the identified property is reduced, the pricing analysis unit 118 may retrieve historical information on the approximate value of each characteristic. In the case of a property with less acreage than the target property, the pricing analysis unit 118 may determine the value of additional acreage to the overall value of a property and adjust the value of the identified property based on the historical information. The historical information may be stored in the memory 210 or secondary storage unit 208 of the dynamic pricing unit 102 or may be located external to the dynamic pricing unit 102.

In step 510, the pricing analysis unit 118 determines weighing values for the target property. The weighing values are determined by analyzing historical sales information on the market to determine specific property characteristics that increase or decrease the value of the property that may not be readily ascertainable by the structure of the property alone. As an illustrative example, a property located within walking distance of public transit may increase the value of a property, while a property located proximate to train tracks may reduce the value of the property. To determine the increase or decrease in the value of the target, the pricing analysis unit 118 uses historical data to determine an increase or decrease in the sale of a property based on a listing of predefined characteristics. The listing of predefined characteristics may be generated based on the geographical location of the property, information on users interested in the property after the initial web posting, estimated demographic information of potential buyers or any other information relating to the value of the property that is not readily apparent from just the structural description of the property alone.

In step 512, the pricing analysis unit 118 determines the minimum value of the target property based on the pricing of the identified properties. The minimum value may be the lowest adjusted priced of the previously identified properties. In step 514, the pricing analysis unit 118 applies weighing factors to the minimum value to determine an initial target price for the property. In step 516, the market analysis unit determines the medium price and high price by adding an incremental value to the target price. The incremental value may be a set predefined value or may be a percentage of the minimum value. As an illustrative example, the medium price may be fixed at $15,000 above the minimum price or 20% above the minimum price.

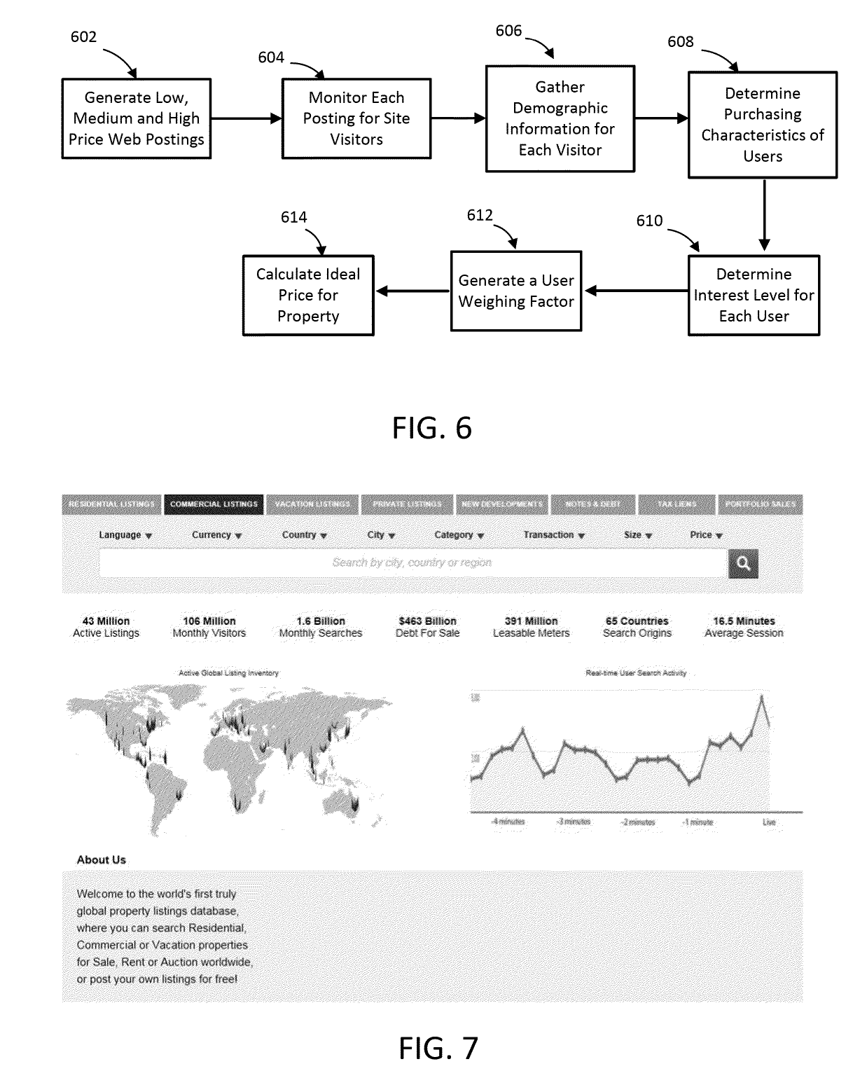

FIG. 6 is an illustrative example of the operation of the property posting unit 116 adjusting the price of the target property based on activity from various web postings of the property. In step 602, the property posting unit 116 posts web pages listing the target property for sale at a low price, a medium price and a high price. The postings may be on the same or different real estate sales web sites, such as realtor.com, Zillow.com or any other real estate sale web site. In step 604, the property posting unit gathers information relating to each posting including, but not limited to, the number of views per hour, day, week and month, the duration each user spends viewing the web page, the number and content of each request for additional information on the property and any other information pertaining to the web postings.

In step 606, the property posting unit 116 gathers information on the user's viewing the web postings including, but not limited to, the income of the user, the user's interest and hobbies, the age and marital status of the user or any other identifying information. The property posting unit 116 gather this information directly or via an external source to provide information on the user. The information may be gathered using known web demographic applications such as Google Analytics. In step 608, the property posting unit 116 determines the purchasing characteristics of each user based on the gathered demographic information. The purchasing characteristics may include a determination of whether a user's income would qualify them for a mortgage to purchase the target property. The purchasing characteristics may also include an analysis of the types and prices of properties historically purchased by users with the same or similar demographic information. The historical purchasing information may be gathered and stored in the memory 212 of the dynamic pricing unit 102 based on prior activity on the web sites and deals brokered through the dynamic pricing unit 102.

In step 610, the property posting unit 116 determines the interest level of each user. The interest level of a user is determined based on their activity on the web posting including the number of times the user viewed the web posting, the number of correspondence initiated by the user concerning the web posting, and any other activity relating to the user's interaction with the web posting. The interest level of each user is assigned a score based on the user's interaction. The score and demographic information for each user is stored in the information storage unit 214.

In step 612, the property posting unit 116 generates a weighing factor based on the user information and interest level. In determining the weighing factor, the property posting unit 116 assigns a score to each of the demographic characteristics of the user including the income level, age, marital status, geographic location or any other demographic characteristic. Further, the property posting unit 116 may assign a weight to the ability of the user to obtain a mortgage based on their income information. The property posting unit 116 adjusts the weighting of each user based on the level of interest with the users with a higher level of interest having an increased weighted value. The property posting unit 116 then determines an overall weighing factor based on the average of all the user's weighing factors.

In step 616, the property posting unit 116 adjusts, via the pricing analysis unit 118, the target price of the property by applying the weighing factor from the web site. As an illustrative example, the target price may be set to the medium price posted on the web site. The user information may indicate that users with an income level well above the amount required to obtain a mortgage have indicated a strong interest in the property. They pricing analysis unit 118 may apply a weighing factor generated by the property posting unit 116 that increases the target price of the property. In this way, the target price reflects not only the market price but also the demographic information of users showing interest in the target property.

FIG. 7 shows a possible embodiment of a website relying on the dynamic pricing technology. In this example, the page includes a world map showing active global listing inventory for property. Multiple different statistics associated with sale and listings are also given along with real time activity graphs. In this model, a user may click to scroll down and select a language of use, a currency, a country, a city, a category, a transaction, a size or even a price. The price for example will be determined using the dynamic pricing system described above. As shown, many other types of properties such as residential listings, commercial listings, vacation listings, private listings, new development listings, notes and debt listings, tax liens, and even portfolio listings can be used as property.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

What is claimed:

1. A dynamic pricing system including a dynamic pricing unit including a memory and a processor, the processor of the dynamic pricing unit executing a program performing the steps of:
gathering a plurality of information on a unit of property, wherein the property is any property but real estate property;
gathering a plurality of information on a market where the unit of property is sold;
generating a first price for the unit of property based on the gathered information on the unit of property and market information;
generating a second price and a third price based on the first price for the unit of property;
posting a portion of the plurality of property information and the first price for viewing by potential buyers on a first web site;
posting a portion of the plurality of property information and the second price for viewing by potential buyers on a second web site;
posting a portion of the plurality of property information and the third price for viewing by potential buyers on a third web site;
monitoring each of the first, second and third web sites to determine the level of interest in the unit of property at each of the first price, second price and third price;
determining a final price based on the interest level of the web posting for the first price, second price and third price; and
posting a portion of the plurality of property information and the final price for viewing by potential buyers on a final web site.

2. The method of claim 1, wherein the unit of property is a collectible property.

3. The method of claim 1, wherein the unit of property is a product.

4. The method of claim 1, wherein the second price is higher than the first price and third price.

5. The method claim 1, wherein the third price is lower than the first price and second price.

6. The method of claim 1, wherein the final price is a value between the first price and second price.

7. The method of claim 1, wherein the market information includes pricing information for a plurality of comparable units of property having similar characteristics as the unit of property.

8. The method of claim 7, including the step of normalizing the pricing information of each of the plurality of comparable units of property based on the information on the unit of property.

9. The method of claim 1, including the step of gathering information relating to users viewing each of the first web page, second web page and third web page.

10. The method of claim 9, including the step of adjusting the final price based on the information relating to users viewing each web site.

11. A dynamic pricing system including:
a property analysis unit configured to gather a plurality of information on a unit of property, wherein the property is any property but real estate property;
a market analysis unit configured to gather a plurality of information on a market where the unit of property is sold;
a property analysis unit configured to:
generate a first price for the unit of property based on the gathered information on the unit of property and market information; and
generate a second price and a third price for the unit of property based on the first price for the unit of property;
a property posting unit configured to:
post a portion of the plurality of property information and the first price for viewing by potential buyers on a first web site;
post a portion of the plurality of property information and the second price for viewing by potential buyers on a second web site;
post a portion of the plurality of property information and the third price for viewing by potential buyers on a third web site; and
monitoring each of the first, second and third web sites to determine the level of interest in the unit of property at each of the first price, second price and third price; and
a pricing analysis unit configured to
determine a final price based on the interest level of the web posting for the first price, second price and third price; and
post a portion of the plurality of property information and the final price for viewing by potential buyers on a final web site.

12. The dynamic pricing system of claim 11, wherein the unit of property is collectible property.

13. The dynamic pricing system of claim 1, wherein the unit of property is a product.

14. The dynamic pricing system of claim 1, wherein the second price is higher than the first price and third price.

15. The dynamic pricing system claim 1, wherein the third price is lower than the first price and second price.

16. The dynamic pricing system of claim 1, wherein the final price is a value between the first price and second price.

17. The dynamic pricing system of claim 1, wherein the market information includes pricing information for a plurality of comparable units of property having similar characteristics as the unit of property.

18. The dynamic pricing system of claim 17, wherein the property analysis unit normalizes the pricing information of each of the plurality of units of property based on the information for the unit of property.

19. The dynamic pricing system of claim 1, wherein the property posting unit gathers information relating to users viewing each of the first web page, second web page and third web page.

20. The method of claim 19, the pricing analysis unit adjusts the final price based on the information relating to users viewing each web site.
